(19) United States
(12) Patent Application Publication
(10) Pub. No.: US 2013/0159839 A1
(43) Pub. Date: Jun. 20, 2013

(54) SEMANTIC COMPRESSION OF CASCADING STYLE SHEETS

(71) Applicants: Flynn Joffray, Vashon, WA (US); Steve Ickman, Redmond, WA (US); William L. Portnoy, Woodinville, WA (US)

(72) Inventors: Flynn Joffray, Vashon, WA (US); Steve Ickman, Redmond, WA (US); William L. Portnoy, Woodinville, WA (US)

(73) Assignee: MICROSOFT CORPORATION, Redmond, WA (US)

(21) Appl. No.: 13/326,047

(22) Filed: Dec. 14, 2011

(51) Int. Cl. G06F 17/00

(52) U.S. Cl. 715/235

(57) ABSTRACT

Embodiments relate to semantic compression of cascading style sheets. Starting with a markup page having markup elements and a reference to a cascading style sheet, based on the reference to the cascading style sheet, the cascading style sheet is retrieved. The cascading style sheet has a plurality of style rules. The cascading style sheet is applied to the markup page to identify one or more of the style rules to be modified or omitted (e.g., rules that are redundant with respect to the markup page or inapplicable to the markup page). A compressed cascading style sheet is generated by excluding the identified rules from the compressed cascading style sheet or modifying the identified rules. The compressed cascading style sheet can then be applied to the markup sheet with similar effect as the uncompressed cascading style sheet.

### BACKGROUND

Originally, markup languages such as the Hypertext Markup Language (HTML) were formatted manually with in-line formatting codes. That is, appearance attributes such as font, size, color, placement, and others would be set within the HTML elements. This approach proved to be inadequate for systematic and organized control of appearance, and content and appearance were difficult to separate. As a result, the World Wide Web Consortium (W3C) established the Cascading Style Sheet (CSS) language. The CSS language consists of a grammar for specifying style rules. An HTML page can link to a CSS style sheet (“style sheet” hereafter), and when the HTML page is rendered, the browser applies style rules in the style sheet to determine the appearance of the HTML page. Different pages may link to the same style sheet, thus allowing a website to have a unified appearance and style.

By design, the CSS language allows multiple rules to apply to a same markup page element, in which case, rules are prioritized according to specificity, order of appearance, source (e.g., embedded, imported, or linked, browser default), etc. This cascading of styles allows a same style sheet to be used for many different pages. As websites have increased in complexity, so too have style sheets. Recently, it is not uncommon for a style sheet to have thousands of style rules. However, large style sheets have disadvantages. Because a style sheet can be transmitted from a web server to a browser many times, a large style sheet can cause significant communications overhead. At the browser, large style sheets can take significant time to process and apply, thus increasing the render time for the related page. Animated pages that are repeatedly rendered can be a problem; the style sheet must be parsed and applied for each loop of animation.

The need to reduce the size of style sheets has been recognized. Previous approaches to style sheet compression include minification, where knowledge of the lexical rules of the CSS language is used to minify a style sheet by removing whitespace, removing comments, etc. It is also possible to compress colors and font weights. However, these techniques are of limited benefit. Minified CSS code is difficult to maintain, and rates of compression can be negligible.

Techniques related to semantic compression of CSS style sheets are discussed below.

### SUMMARY

The following summary is included only to introduce some concepts discussed in the Detailed Description below. This summary is not comprehensive and is not intended to delineate the scope of the claimed subject matter, which is set forth by the claims presented at the end.

Embodiments relate to semantic compression of cascading style sheets. Starting with a markup page having markup elements and a reference to a cascading style sheet, based on the reference to the cascading style sheet, the cascading style sheet is retrieved. The cascading style sheet has a plurality of style rules. The cascading style sheet is applied to the markup page to identify one or more of the style rules to be modified or omitted (e.g., rules that are redundant with respect to the markup page or inapplicable to the markup page). A compressed cascading style sheet is generated by excluding the identified rules from the compressed cascading style sheet or modifying the identified rules. The compressed cascading style sheet can then be applied to the markup sheet with similar effect as the uncompressed cascading style sheet.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows an example of semantic CSS compression.

FIG. 2 shows a process for semantic CSS compression performed by CSS a compressor.

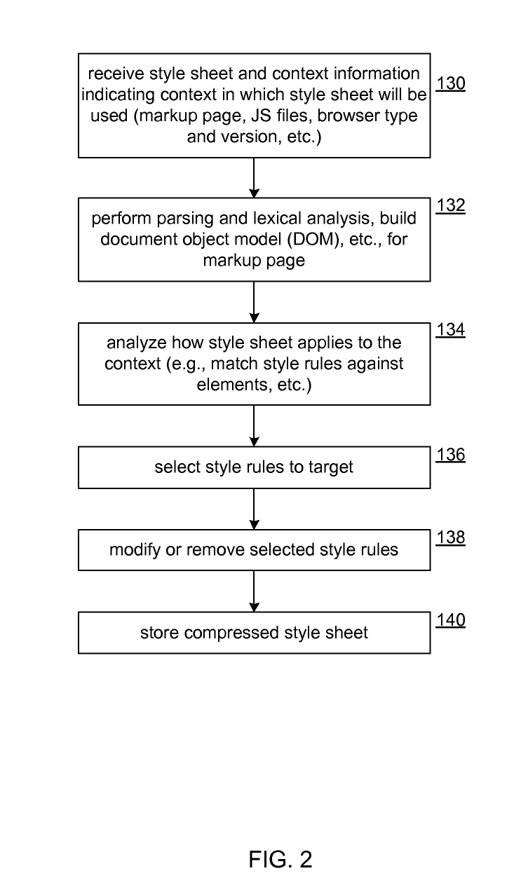

FIG. 3 shows a server-based implementation of semantic CSS compression.

FIG. 4 shows an example where semantic CSS compression is performed at the client device.

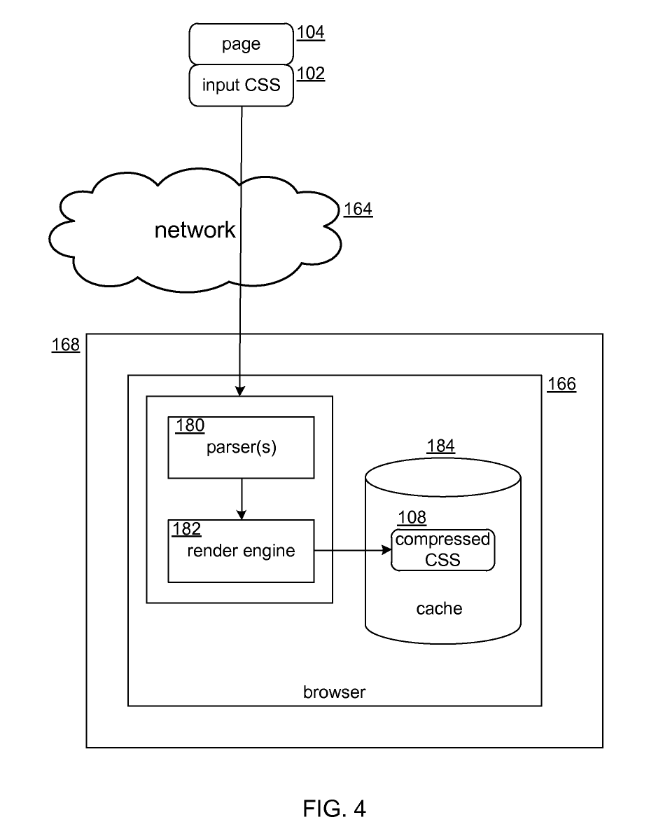

FIG. 5 shows a detailed view of a CSS compressor.

FIG. 6 shows an example computing device.

### DETAILED DESCRIPTION

Embodiments discussed below relate to semantic compression of CSS style sheets. Discussion will begin with an overview of how information about the context in which a style sheet will be rendered can be leveraged to rework the style sheet in a manner that fits its immediate use. Server-based and client-based applications of the technique will then be described, followed by details about different types of context information and how they can be used to identify target style rules. Note that the techniques described herein can be applied to any type of markup language, including past and future versions, such as HTML, extensible HTML, extensible markup language (XML), or any other markup language to which CSS code can be applied. In addition, the techniques can be applied to any CSS code that complies with past or future definitions of the CSS language (e.g., CSS4, should it arise). The techniques can also be applied to other languages that are sufficiently similar to the CSS language.

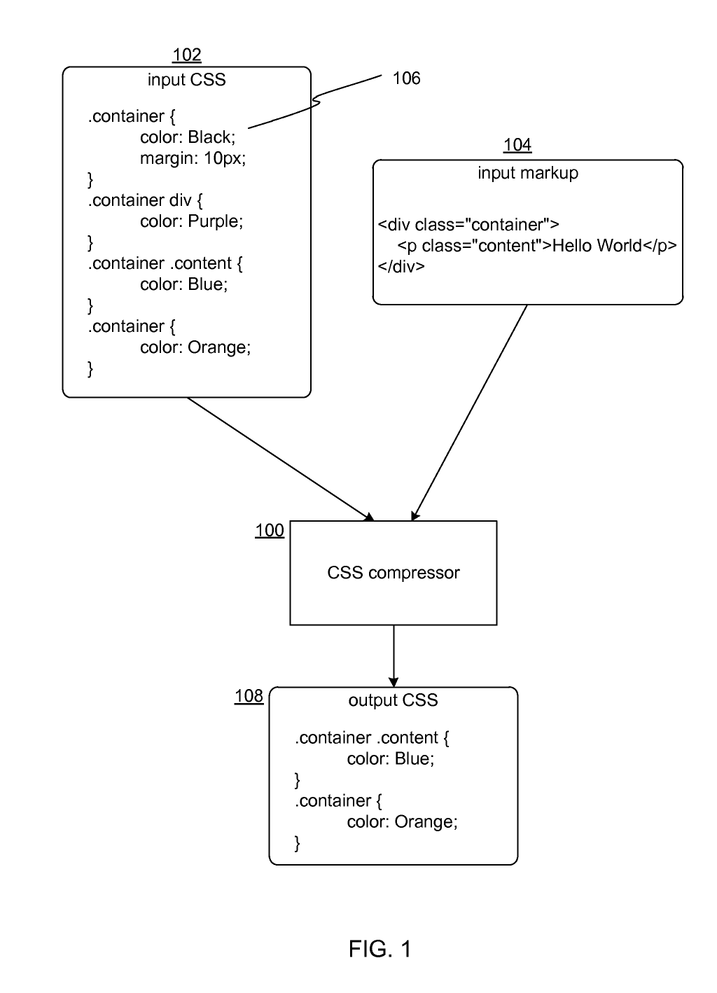

FIG. 1 shows an example of semantic CSS compression. A CSS compressor 100 receives an input style sheet 102 and an input markup page 104. The input style sheet 102 has a number of style rules 106. In accordance with some version of the CSS language, each style rule (sometimes referred to as a rule-set) has one or more selectors such as “.container” and “.container div”, and a rule block having one or more declarations. Each declaration specifies a property and a value. For example, the first style rule in input style sheet 102 has two declarations, the first specifying that the color property has a value of “Black”. The input markup page 104 has a div element with an attribute setting its class to be “container”. A style rule applies to an element if its selector matches the element, including familial qualifications. For example, the “.container div” selector matches a “div” element that is the child of an element of the “container” class.

The CSS compressor 100 in effect performs part of the process that a browser would use to render a markup page. The CSS compressor 100 may use any of the known techniques for CSS parsing and markup parsing to parse the input style sheet 102 and input markup page 104, forming respective data structures or objects in memory that represent the inputs. For example, the input markup page 104 may be represented as a document object model (DOM) instance, and the input style sheet 102 may be represented as hash tables storing the individual style rules. The CSS compressor 100 uses the data structures or objects representing the input to determine how and whether the style rules apply to the elements of the input markup page 104. Again, known techniques for applying style rules can be used. Details on priority and conflict resolution (i.e., cascading) of style rules are described elsewhere.

As the style rules are applied and the rendering process is partially simulated, information about the individual style rules is accumulated in the data structure or object that represents the style sheet. For example, style rules that are not used for the particular input markup page 104 are marked or identified. According to the DOM representation of the input markup page 104, style rules that as a whole have a same effect on an entire subtree of the DOM instance (e.g., through inheritance) can be consolidated to a style rule that applies to the root element of that subtree, modified to have a selector of a corresponding class, etc. Style rules that only apply to a single element can be condensed to a single style rule with an appropriate selector having the corresponding declarations. In embodiments described in detail later, other or additional information about the context within which the input markup page 104 will be rendered is taken into account. For example, script code embedded or linked in the input markup page 104 may be parsed and analyzed to identify markup elements, a browser type or version may be used to help tune the rule-application process (e.g., a browser might not support the target of a style rule), etc.

Finally, when the CSS compressor 100 has finished identifying semantic optimizations for the input style sheet 102, the CSS compressor 100 outputs a compressed style sheet 108. The compressed style sheet 108 is a version of the input style sheet 102, but with select style rules omitted, refactored, rearranged, etc. according to the analysis discussed above. In the example of FIG. 1, CSS compressor 100 recognized that the style rules with the “container” class selector could be consolidated into a single style rule and that only the “color: orange” and “margin: 10px” declarations were applicable to the input markup page 104; thus the omission of the “color: Black” declaration. Also, the selector “.container .content” was more specific than the generic version, which was deemed unnecessary and deleted.

The process may be performed by a web server or a web browser. At step 130 a style sheet that is to be compressed is received, along with context information relating to use of the style sheet. At step 132 the style sheet is parsed and analyzed with reference to the context information. Again, existing techniques for applying CSS code can be modified to parse the style sheet. At step 134 the style sheet is analyzed, building information about how the style rules in the style sheet apply to the current context and also building information about the style sheet itself. At step 136 target style rules are selected, and at step 138 the target style rules are handled accordingly, e.g., they are removed, modified, reordered, consolidated, etc. At step 140 a compressed style sheet with the remaining and reordered or modified style rules is outputted and stored in memory or storage for later use with respect to the corresponding web page(s). Note that semantic modification of a style rule refers to changing the semantic (substantive) content of a style rule, as opposed to merely changing the lexical content (e.g., removing whitespace). For example, modifying semantic content of a style rule may include adding a declaration, removing a declaration, adding or removing a class, element (tag) name, ID to the selector, etc.

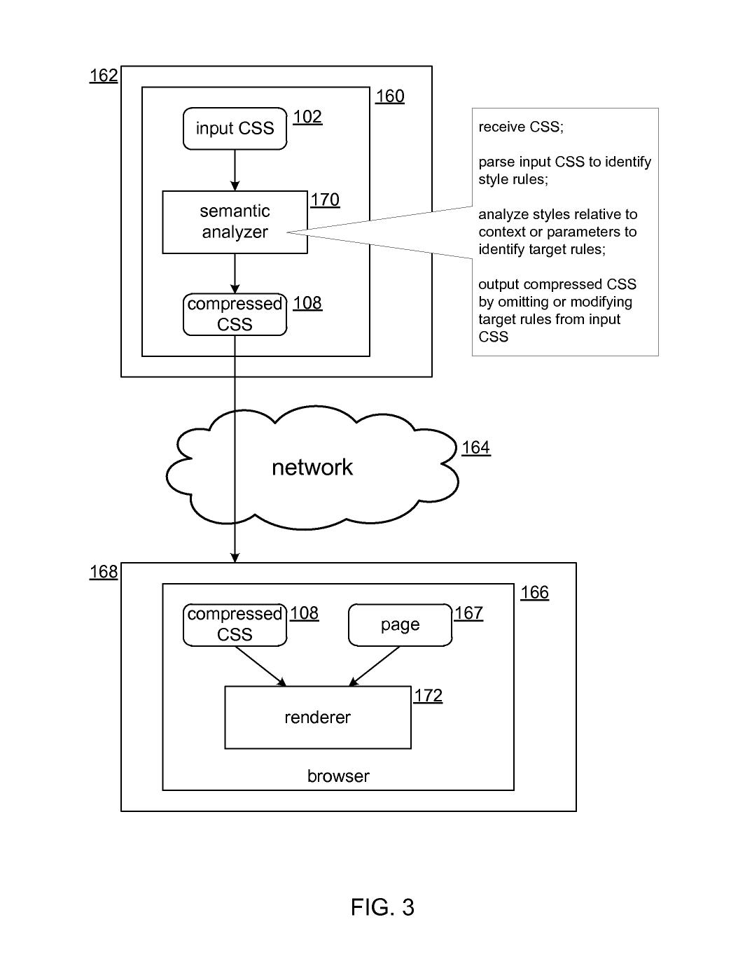

FIG. 3 shows a server-based implementation of semantic CSS compression. A web server 160, running on a server device 162 or cluster is assumed to have received, via a network 164, a request for a web page from a web browser 166 executing on a client device 168. The web server 160 recognizes that the requested web page imports or links to the input style sheet 102. This causes the web server 160 to pass the input style sheet 102 to a semantic analyzer 170. The semantic analyzer 170 in effect handles the web page somewhat as a browser would, for instance parsing the web page, parsing the input style sheet 102, handling each element in the web page to identify pertinent style rules, cascading the style rules, etc. During this process, the semantic analyzer 170 accumulates information about the style rules in the input style sheet 102 (as well as inherent traits of the input style sheet 102), including possibly which rules match which nodes in a DOM of the requested web page. When the web page has been processed, the semantic analyzer 170 refactors the style rules and outputs the compressed style sheet 108 in place of the original input style sheet 102. The compressed style sheet 108 is transmitted to the client machine transparently; the user has no visibility of the compression of the styles to be applied to the inbound web page. At the client device 168, the browser 166's renderer 172 renders the web page using the compressed style sheet 108.

Although client-side compression might not have the network-bandwidth savings of the server-based approach of FIG. 3, compression at the client device 168 can nonetheless reduce the time that it takes to apply the style sheet to future renderings of the corresponding web page. The browser 166 receives an input web page 167 (a type of markup page 104) and input style sheet 102. The browser has a parser 180 and render engine 182 that cooperate to identify semantic traits of style rules in the input style sheet 102. The input style sheet 102 is compressed using techniques described herein. The compressed style sheet 108 is then stored in the browser 166's cache 184. When the input web page 167 is again to be rendered, the compressed version in the cache 184 is used, thus reducing the overhead of displaying the related input web page 167.

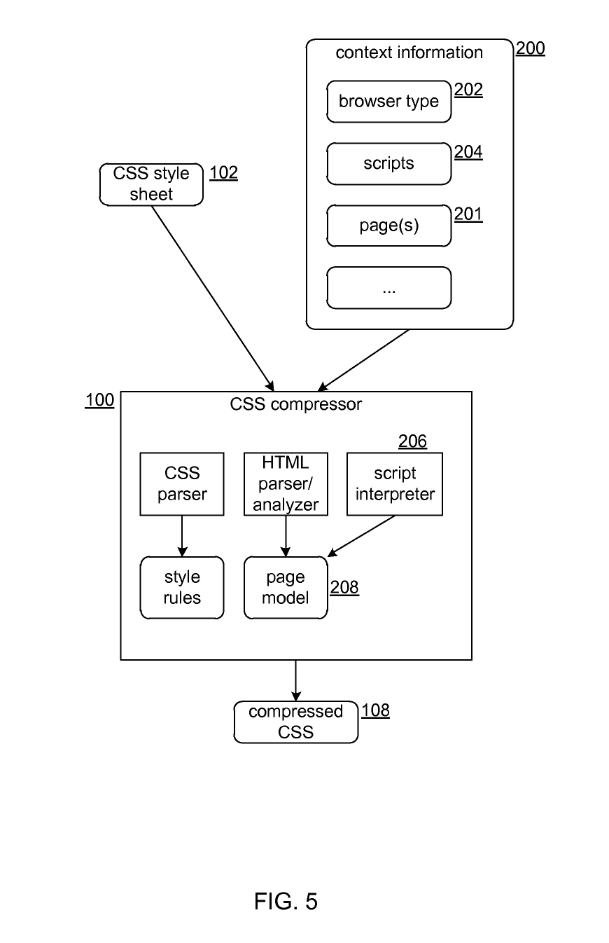

FIG. 5 shows a detailed view of the CSS compressor 100. The CSS compressor 100 may be implemented on either a client or server as discussed above. The CSS compressor 100 receives the input style sheet 102 as well as context information 200. The context information 200 may include one or more types of information relevant to how a web page will be rendered. As discussed above, the context information 200 may include one or more markup pages 201 to be rendered with reference to the input style sheet 102. The context information 200 may also include browser information 202 such as the type or version of the browser that will be using the input style sheet 102, information about software on the browser (e.g., Java™ version or settings), information about default settings of the browser, including a default style sheet, and so on. The browser information 202 can be used, for example, to inform the style evaluation process. If the indicated browser does not support a certain type of style or declaration, then that style or declaration can be discarded. If the browser does not recognize certain types of page elements, for example, then related style rules can be marked accordingly.

The context information 200 may also include script information 204. The script information 204 may be a JavaScript (JS) script, for example, linked or embedded in a web page to be rendered. Given a JS script, a script interpreter 206 might analyze or execute the JS script to identify document elements in the page model 208 that are added, removed, or modified by the JS script. The CSS compressor might also recognize that the JS script generates CSS styles to be added to the DOM of the web page (using JQueries), which can also inform the CSS analysis; a script-generated style rule might moot a style rule in the input style sheet 102. One approach is to execute the is script and allow it to modify the page model 208, and then apply style rules to the resulting page model 208.

The context information 200 may include other information, such as session settings and parameters, server default settings, etc. For example, the server may have a default setting of ignoring style rules with certain properties. The user may have a session variable that indicates that imprecise rendering is acceptable, thus allowing some style rules to be modified or omitted. In one embodiment, the context information 200 may contain information about pages of a model-view-controller (MVC) system. For example, the fact that a page is part of an MVC system may trigger compression. As discussed above, the markup code (e.g., HTML) and JS code being used is analyzed. The CSS compressor 100 may then revise the corresponding style sheet, for example by tracking the classes and identifiers of the HTML and JS code and cross referencing them against the corresponding style sheet, then making choices about which specific declarations are redundant (and can be removed) in parent or children selectors. In one embodiment, markup can be prioritized for compression based on specificity of cascading style rules.

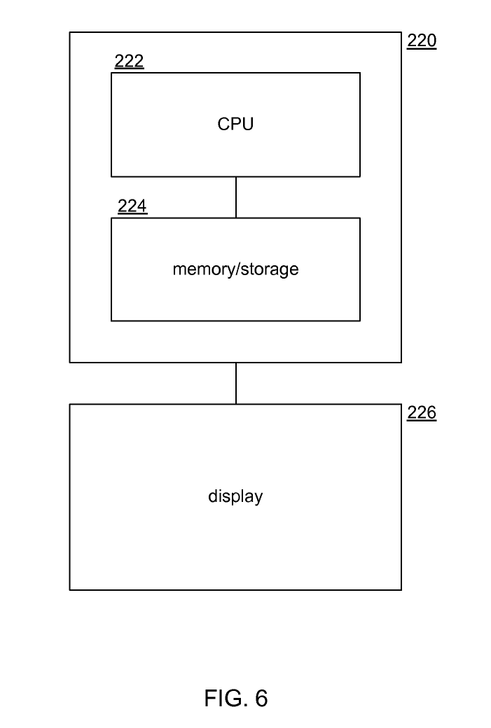

FIG. 6 shows an example computing device 220 on which one or more embodiments described above may be implemented. The computing device 220 is only an example of the type of device that server device 162 and client device 168 may be. The computing device 220 may include a processor 222 cooperating with memory and/or storage 224 to perform steps and processes mentioned above. The computing device 220 may also have a display 226, for example to display rendered HTML output.

The memory and/or storage 224 may be in the form of volatile and/or non-volatile computer or device readable media, storing information to implement embodiments described above. This media is deemed to include at least media such as optical storage (e.g., compact-disk read-only memory (CD-ROM)), magnetic media, flash read-only memory (ROM), or any current or future means of storing digital information for ready interchange with the computing device 220. The stored information can be in the form of machine executable instructions (e.g., compiled executable binary code), source code, bytecode, or any other information that can be used to enable or configure computing devices to perform the various embodiments discussed above. This is also deemed to include at least volatile memory such as random-access memory (RAM) and/or virtual memory storing information such as central processing unit (CPU) instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A method performed by a computing device for compressing a cascading style sheet to be used to render a markup page, the method comprising:
parsing the cascading style sheet to identify style rules therein;
performing semantic analysis on the style rules to select one or more target style rules from among the identified style rules; and
outputting and storing a compressed version of the cascading style sheet by making a semantic modification to the cascading style sheet, wherein the semantic modification is either omitting a target style rule or modifying semantic content of a target style rule.

2. A method according to claim 1, wherein the semantic modification is modifying the semantic content of the target style rule, and wherein the modifying the semantic content comprises either adding a declaration to the target style rule, removing a declaration from the target style rule, or adding to or removing from the selector of the target style rule either a class, element (tag) name, or ID.

3. A method according to claim 1, further comprising parsing a markup page, the markup page to be rendered by a browser with reference to the cascading style sheet, and based on the markup page selecting a target style rule that is to be omitted from the compressed cascading style sheet.

4. A method according to claim 3, wherein the selected target style rule that is to be omitted is selected by determining that the target style rule does not apply to any markup elements in the cascading style sheet.

5. A method according to claim 1, further comprising parsing a script referenced or embedded in a markup page to be rendered according to the cascading style sheet, and making the semantic modification based on the script.

6. A method according to claim 1, wherein the cascading style sheet has a style rule that is not included in the compressed version of the cascading style sheet.

7. A method according to claim 1, further comprising receiving the cascading style sheet in response to a request from a browser for a web page associated with the cascading style sheet, and transmitting the compressed version of the cascading style sheet to the browser.

8. One or more computer-readable storage media storing information to enable a computing device to perform a process, the process comprising:
receiving a markup page comprising markup elements and a reference to a cascading style sheet;
based on the reference to the cascading style sheet, retrieving the cascading style sheet, the cascading style sheet comprising a plurality of style rules, each style rule comprising a selector and one or more declarations, each declaration identifying a property and a value;
applying the cascading style sheet to the markup page to identify one or more of the style rules as either redundant with respect to the markup page or inapplicable to the markup page; and
generating a compressed cascading style sheet comprised of some of the style rules from the cascading style sheet, wherein a style rule identified as either redundant or inapplicable is not included in the compressed cascading style sheet.

9. One or more computer-readable storage media according to claim 8, wherein the process is performed by a server and the process is performed in response to the server receiving a request from a web browser for the markup page.

10. One or more computer-readable storage media according to claim 8, the process further comprising identifying a first style rule and a second style rule as both being applicable to a same element of the markup page.

11. One or more computer-readable storage media according to claim 10, the process further comprising adding a declaration from the first style rule to the second style rule, and omitting the first style rule from the compressed cascading style sheet.

12. One or more computer-readable storage media according to claim 8, wherein the cascading style sheet conforms to a version of the Cascading Style Sheet (CSS) language, and the applying the cascading style sheet to the markup page comprises, for a given element of the markup page, identifying a plurality of the style rules by matching the selectors of the style rules in the plurality with the markup page, and applying cascade rules of the CSS language to the identified plurality of the style rules to determine that a target style rule is redundant or inapplicable.

13. One or more computer-readable storage media according to claim 12, wherein the determined target style rule has a selector that partially matches a selector of another style rule in the plurality of style rules.

14. One or more computer-readable storage media according to claim 8, further comprising receiving context information indicating information about a context of rendering the markup page on a client device and using the context information to identify the redundant or inapplicable style rules.

15. A method performed by one or more computing devices, the method comprising:
using a markup page to select one or more target style rules in a cascading style sheet that is associated with the markup page for the purpose of a browser rendering the markup page;
deleting the selected one or more target style rules from the cascading style sheet; and
after the deleting, storing the cascading style sheet as a compressed cascading style sheet.

16. A method according to claim 15, further comprising adding or removing an element name, ID, or class to or from the cascading style sheet.

17. A method according to claim 15, wherein a script is associated with the markup page, and the selecting of the one or more target style rules is further based on the script.

18. A method according to claim 17, further comprising parsing the script to identify a markup element referenced in the script.

19. A method according to claim 17, further comprising parsing the script to identify style sheet rule that would be generated by execution of the script.

20. A method according to claim 15, further comprising deleting one or more style rules determined to be unparseable or invalid.
